(19) United States
(12) Patent Application Publication
(10) Pub. No.: US 2020/0096528 A1
(43) Pub. Date: Mar. 26, 2020

(54) SAMPLE TRANSFER DEVICE

(71) Applicant: Shimadzu Corporation, Kyoto (JP)

(72) Inventor: Yuki KOMORI, Kyoto (JP)

(21) Appl. No.: 16/560,129

(22) Filed: Sep. 4, 2019

(30) Foreign Application Priority Data
Sep. 26, 2018 (JP) 2018-180553

(51) Int. Cl. G01N 35/04

(52) U.S. Cl. CPC G01N 35/04; G01N 2001/002

(57) ABSTRACT

This sample transfer device is provided with a negative pressure supply unit for supplying negative pressure, a sample container holding unit for holding a sample container, a container suction member exchangeably provided to the sample container holding unit and configured to suction the sample container by the supplied negative pressure, and a control unit that performs control to determine a state of the container suction member based on a predetermined pressure value determined based on a size of the container suction member and magnitude of the negative pressure in the container suction member.

### CROSS-REFERENCE TO THE RELATED APPLICATIONS

The priority application number JP2018-180553, entitled “SAMPLE TRANSFER DEVICE”, filed on Sep. 26, 2018, and invented by Yuki Komori upon which this patent application is based is hereby incorporated by reference.

### BACKGROUND OF THE INVENTION

### Field of the Invention

The present invention relates to a sample transfer device, and more particularly to a sample transfer device for transferring a sample container containing a sample.

### Description of the Background Art

Conventionally, a sample transfer device for transferring a sample container containing a sample is known. Such a sample transfer device is disclosed in, for example, Japanese Unexamined Patent Application Publication No. 2015-197444.

Japanese Unexamined Patent Application Publication No. 2015-197444 discloses a sample transfer device configured to transfer a sample container by holding a sample container in a state in which a portion to be engaged provided at a lid portion of the sample container and an engaging portion provided at a rod-like supporting member are engaged.

According to the configuration disclosed in Japanese Unexamined Patent Application Publication No. 2015-197444, a sample container is held by an engagement between an engaging portion and a portion to be engaged, and therefore it is necessary to use a dedicated sample container provided with a portion to be engaged. Therefore, there is a disadvantage that it is not possible to use a general sample container not provided with a portion to be engaged. Therefore, although not disclosed in Japanese Unexamined Patent Application Publication No. 2015-197444, in order to solve the above-mentioned inconvenience, it is conceivable to propose a configuration in which a sample container is held by suctioning a sample container with a sample container holding unit provided with a container suction member. In the case of this configuration, a sample container can be held without using a dedicated sample container because a sample container is suctioned using the container suction member.

However, even in the case of using a sample container holding unit provided with a container suction member, depending on the state of the container suction member, such as, e.g., when the container suction member has deteriorated, there is an inconvenience that the sample container may not be held properly. In this case, by exchanging the container suction member according to the state of the container suction member, it is possible to prevent that the sample container becomes unable to be normally held. However, there is a problem that it is not possible to grasp the replacement time of the container suction member until after the sample container has become unable to be held properly.

The present invention has been made to solve the above-mentioned problems, and one object of the present invention is to provide a sample transfer device capable of grasping a replacement time of a container suction member before it becomes a state in which a sample container holder cannot hold a sample container normally when holding the sample container by suctioning the sample container.

### SUMMARY OF THE INVENTION

In order to attain the aforementioned object, a sample transfer device according to one aspect of the present invention includes: a negative pressure supply unit configured to supply negative pressure; a sample container holding unit configured to hold a sample container; a container suction member exchangeably attached to the sample container holding unit and configured to suction the sample container by the supplied negative pressure; and a control unit configured to perform control to determine a state of the container suction member based on a predetermined pressure value determined based on a size of the container suction member and magnitude of the negative pressure in the container suction member.

The sample transfer device according to one aspect of the present invention is, as described above, provided with a container suction member configured to suction a sample container by the supplied negative pressure and a control unit configured to perform control to determine the state of the container suction member based on a predetermined pressure value determined based on a size of the container suction member and magnitude of the negative pressure in the container suction member.

According to this configuration, since the magnitude of the negative pressure in the container suction member changes depending on the state of the container suction member, it is possible to determine whether the container suction member can suction the sample container, so that it is possible to determine whether it is necessary to replace the container suction member. As a result, before the sample container holding unit becomes a state in which it cannot hold the sample container normally, it is possible to grasp the replacement time of the container suction member.

In the sample transfer device according to the aforementioned one aspect of the present invention, preferably, the control unit is configured to perform control to distinguishably determine whether the container suction member has deteriorated or a shape of the container suction member is mismatched with respect to the lid portion of the sample container, based on the magnitude of the negative pressure.

By configuring as described above, it is possible to grasp the cause that the sample container holding unit becomes a state in which it cannot hold the sample container normally is due to the deterioration of the container suction member or the shape of the container suction member is mismatched with respect to the lid portion of the sample container. As a result, when exchanging the container suction member, it is possible to determine whether it should be replaced with a container suction member that has the same size, etc., as the container suction member before the replacement and that has not deteriorated or it should be replaced with a container suction member having a size, etc., different from the container suction member before the replacement.

In this case, preferably, the sample transfer device further includes a storage unit configured to store a determination result of the control unit, wherein the control unit is configured to perform control to distinguishably determine whether the container suction member has deteriorated or the shape of the container suction member is mismatched with respect to a lid portion of the sample container, based on time series detection results of the negative pressure.

By configuring as described above, depending on whether the magnitude of the negative pressure in the container suction member gradually decreased (over time) or the magnitude of the negative pressure in the container suction member suddenly decreased after replacing the container suction member, it is possible to accurately determine the cause that the sample container holding unit became unable to hold the sample container properly. As a result, compared with the configuration that determines the state of the container suction member based only on the negative pressure detection result at a certain time point, it is possible to more accurately determine the cause of the decrease in the holding force of the sample container holding unit from the normal value. Thus, it can be accurately determined that it should be replaced with what kind of a container suction member.

In the configuration in which the determination of the container suction member is performed based on the aforementioned time series detection results of the negative pressure, preferably, the control unit is configured to perform control to determine that the container suction member has deteriorated based on the magnitude of the negative pressure supplied to the container suction member, a first threshold value, and a second threshold value smaller than the first threshold value when the negative pressure has changed from a first negative pressure state in which the negative pressure is larger than the first threshold value to a third negative pressure state in which the negative pressure is equal to or smaller than the second threshold value via a second negative pressure state in which the negative pressure is equal to or smaller than the first threshold value and larger than the second threshold value

By configuring as described above, the pressure value in the container suction member gradually decreases. This makes it possible to determine that the container suction member has deteriorated, so that the deterioration state of the container suction member can be grasped in detail. As a result, it is possible to grasp the deterioration status of the container suction member in detail, which enables to grasp the appropriate replacement time of the container suction member.

In the configuration in which the determination of the container suction member is performed based on the time series detection result of the negative pressure, preferably, the control unit is configured to perform control to determine that the shape of the container suction member is mismatched with respect to the lid portion of the sample container based on the magnitude of the negative pressure supplied to the container suction member, a first threshold value, and a second threshold value smaller than the first threshold value when the negative pressure has not become a first negative pressure state in which the negative pressure is greater than the first threshold value and has become a second negative pressure state in which the negative pressure is equal to or smaller than the first threshold value and larger than the second threshold value, or has become a third negative pressure state in which the negative pressure is equal to or smaller than the second threshold value.

By configuring as described above, when the negative pressure state of the container suction member has become the second negative pressure state or the third negative pressure state without passing through the first negative pressure state, it becomes possible to determine that the shape of the container suction member is mismatched with respect to the lid portion of the sample container, which in turn makes it possible to determine whether the cause that the sample container holding unit cannot hold the sample container normally is a mismatch of the shape of the container suction member with respect to the lid portion of the sample container. As a result, unlike the case where the container suction member has deteriorated, the user can confirm whether the prompt replacement is necessary according to the negative pressure state of the container suction member.

In the configuration in which it is determined whether the container suction member has deteriorated or the shape of the container suction member is mismatched with respect to the lid portion of the sample container based on the negative pressure state of the container suction member, preferably, the sample transfer device further includes a notification unit configured to notify that a state of the container suction member is which of the first negative pressure state, the second negative pressure state, and the third negative pressure state.

By configuring as described above, the user can grasp the state of the container suction member based on the notification content of the notification unit. As a result, for example, regardless of the environment in which the sample transfer device is installed, as compared with the case in which the container suction member is exchanged based on the duration of use (used time) or the number of uses of the container suction member, it is possible to determine the replacement time based on the state of the container suction member. Therefore, the container suction member can be exchanged at the timing appropriate for the environment in which the sample transfer device is installed.

In the sample transfer device according to the above one aspect of the present invention, preferably, the sample transfer device further includes a holding determination unit configured to determine whether the sample container holding unit is holding the sample container based on the magnitude of the negative pressure supplied to the sample container holding unit.

By configuring as described above, based on the magnitude of the negative pressure supplied to the sample container holding unit, it is possible to grasp whether the sample container holding unit is holding the sample container. As a result, for example, as compared with the case in which the sample container is held using a magnet or the like, it can be more accurately grasped whether the sample container could be held. Further, based on the number of times that the sample container holding unit failed to hold the sample container, it is possible to grasp whether the size of the sample container holding unit or the like with respect to the sample container is appropriate.

In the sample transfer device according to the above one aspect of the present invention, preferably, the sample transfer device further includes: a sample suction and discharge unit configured to suction a sample from the sample container and discharge the sample at a predetermined position; a horizontal direction moving mechanism configured to integrally move the sample container holding unit together with the sample suction and discharge unit in a horizontal direction; and a vertical direction moving mechanism configured to independently move the sample container holding unit and the sample suction and discharge unit in a vertical direction.

By configuring as described above, it becomes possible to integrally move the sample suction and discharge unit and the sample container holding unit, which in turn can simplify the device configuration and suppress the increase in size of the device. Also, by moving the sample container holding unit and the sample suction and discharge unit independently in the vertical direction, when holding the sample container by the sample container holding unit, it is possible to suppress that the sample suction and discharge unit comes into contact with other sample containers. Therefore, unlike the configuration in which the movement of the sample container holding unit and the movement of the sample suction and discharge unit in the vertical direction are integrally performed, there is no need to consider that the sample container holding unit and the sample suction and discharge unit interfere with each other. This enables to suppress the complication of the device configuration. As a result thereof, by grasping the state of the container suction member, in the sample transfer device capable of grasping the appropriate replacement time of the container suction member, it is possible to suppress the increase in size of the device and the complication of the device configuration.

In this case, preferably, the sample transfer device further includes: a preprocessing unit configured to perform preprocessing of the sample to be analyzed by a chromatography apparatus, wherein the horizontal direction moving mechanism and the vertical direction moving mechanism are configured to move the sample container from a sample container placement portion to the preprocessing unit by moving the sample container holding unit to perform the preprocessing of the sample, and wherein the sample suction and discharge unit is configured to suction the sample after the preprocessing and discharge the sample to a sample inlet port of the chromatography apparatus.

By configuring as described above, it becomes possible to grasp the replacement time of the container suction member. Therefore, for example, when the sample container is transferred to a preprocessing unit and preprocessed and then the analysis is performed by the chromatography apparatus, it is possible to assuredly perform the sample preprocessing. As a result, in the case of analyzing a sample subjected to the preprocessing using the chromatography apparatus, the present invention can be preferable to applied.

### BRIEF DESCRIPTION OF THE DRAWINGS

FIG. 1 is a block diagram showing an entire configuration of a sample transfer device according to a first embodiment.

FIG. 2 is a schematic diagram of the sample transfer device according to the first embodiment as viewed from above.

FIG. 3 is a schematic diagram as viewed from the side of the sample transfer device according to the first embodiment.

FIG. 4 is a diagram of a mechanism for moving a sample suction and discharge unit in the vertical direction according to the first embodiment.

FIG. 5 is a schematic diagram of a sample container to be transferred by the sample transfer device according to the first embodiment.

FIG. 6 is a cross-sectional view taken along the line 500-500 in FIG. 5.

FIG. 7 is a schematic diagram of a lid portion of the sample container to be transferred by the sample transfer device according to the first embodiment as viewed from above.

FIG. 8 is a schematic diagram of the state in which the container suction member according to the first embodiment and the sample container are in contact with each other.

FIG. 9A is a schematic diagram for explaining a size of the container suction member according to the first embodiment.

FIG. 9B is a schematic diagram for explaining a size of a needle penetration portion according to the first embodiment.

FIG. 10A is a schematic diagram for explaining the movement of the sample container holding unit according to the first embodiment in the horizontal direction.

FIG. 10B is a schematic diagram for explaining the movement of the sample container holding unit according to the first embodiment in the vertical direction.

FIG. 10C is a schematic diagram for explaining the processing when the sample container holding unit according to the first embodiment supplies negative pressure.

FIG. 10D is a schematic diagram for explaining the processing in which the sample container holding unit according to the first embodiment holds the sample container.

FIG. 10E is a schematic diagram for explaining a movement of the sample container holding unit in the horizontal direction after the sample container holding unit according to the first embodiment holds the sample container.

FIG. 10F is a schematic diagram for explaining a movement of the sample container holding unit in the vertical direction after the sample container holding unit according to the first embodiment holds the sample container.

FIG. 10G is a schematic diagram for explaining the processing in which the sample container holding unit according to the first embodiment stops the supply of negative pressure.

FIG. 10H is a schematic diagram for explaining processing in which the sample container holding unit according to the first embodiment places the sample container.

FIG. 11 is a schematic diagram for explaining determination criteria when the holding determination unit according to the first embodiment determines whether the sample container is held.

FIG. 12 is a flowchart for explaining the processing in which the holding determination unit according to the first embodiment determines whether the sample container could be held.

FIG. 13 is a flowchart for explaining the processing in which the control unit according to the first embodiment determines the state of the container suction member.

FIG. 14 is a block diagram showing an entire configuration of a sample transfer device according to a second embodiment.

FIG. 15 is a flowchart for explaining the processing in which the holding determination unit according to the second embodiment determines whether the sample container could have been transferred to a predetermined position.

FIG. 16 is a side view showing the arrangement of the sample container holding unit and the sample suction and discharge unit according to the first modification.

FIG. 17A is a schematic diagram showing the positional relationship between a container suction member and a needle according to a first modification.

FIG. 17B is a schematic diagram for explaining the structure of the contact suction member according to the first modification.

FIG. 18 is a schematic diagram of a negative pressure supply unit according to a second modification.

FIG. 19 is a block diagram showing an entire configuration of a sample transfer device according to a third modification.

### DESCRIPTION OF PREFERRED EMBODIMENTS

Hereinafter, embodiments embodying the present invention will be described with reference to the drawings.

### First Embodiment

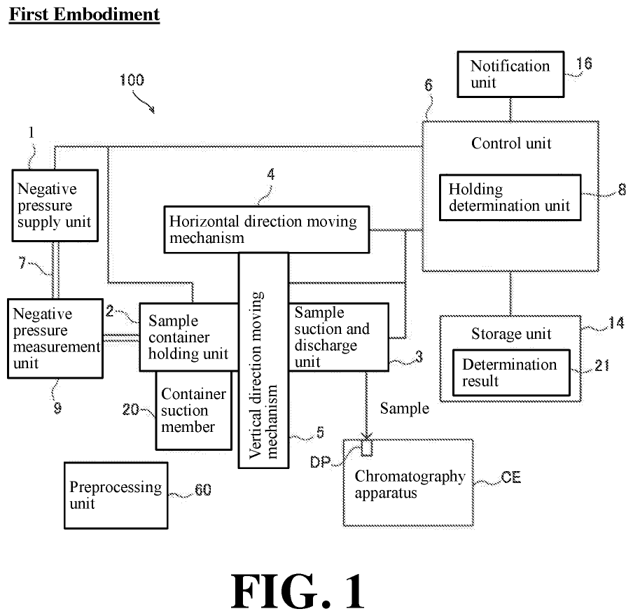

With reference to FIG. 1 to FIG. 4, a configuration of a sample transfer device 100 according to a first embodiment of the present invention will be described.

### Configuration of Sample Transfer Device

First, with reference to FIG. 1, the configuration of the sample transfer device 100 according to the first embodiment will be described.

As shown in FIG. 1, the sample transfer device 100 is provided with a negative pressure supply unit 1, a sample container holding unit 2, a sample suction and discharge unit 3, a horizontal direction moving mechanism 4, a vertical direction moving mechanism 5, a control unit 6, and a negative pressure measurement unit 9, a storage unit 14, a notification unit 16, and a preprocessing unit 60.

The negative pressure supply unit 1 is configured to supply negative pressure to the sample container holding unit 2 under the control of the control unit 6. Specifically, the negative pressure supply unit 1 is configured to supply negative pressure to the sample container holding unit 2 by suctioning air. The negative pressure supply unit 1 includes, for example, a vacuum pump.

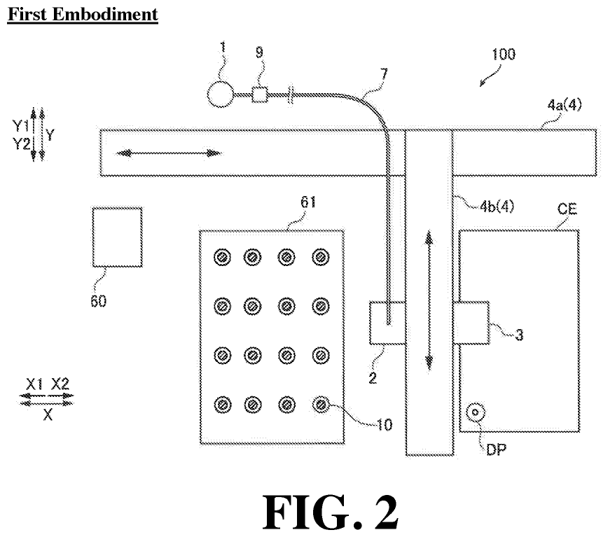

The sample container holding unit 2 is connected to the negative pressure supply unit 1 by a tubular member 7 (see FIG. 2) and is configured such that negative pressure is supplied from the negative pressure supply unit 1. The sample container holding unit 2 is configured to hold the sample container 10 (see FIG. 2) by the supplied negative pressure. Specifically, the sample container holding unit 2 is configured to hold the sample container 10 by suctioning the sample container 10 by the negative pressure supplied in a state of being in contact with the sample container 10. The details of the configuration in which the sample container holding unit 2 holds the sample container 10 will be described later.

The sample suction and discharge unit 3 is configured to suction the sample from the sample container 10 and discharge the sample at a predetermined position. The sample suction and discharge unit 3 has a needle 30 for suctioning and discharging the sample. The needle 30 is, for example, a suction tube having a hollow structure. The sample suction and discharge unit 3 includes, for example, a syringe connected to the needle 30.

The horizontal direction moving mechanism 4 is configured to integrally move the sample container holding unit 2 together with the sample suction and discharge unit 3 in the horizontal direction under the control of the control unit 6. The details of the configuration of the horizontal direction moving mechanism 4 will be described later.

The vertical direction moving mechanism 5 is configured to move the sample container holding unit 2 and the sample suction and discharge unit 3 independently in the vertical direction under the control of the control unit 6. The details of the configuration of the vertical direction moving mechanism 5 will be described later.

The control unit 6 is configured to supply negative pressure to the sample container holding unit 2 by controlling the negative pressure supply unit 1. Further, the control unit 6 is configured to integrally move the sample container holding unit 2 and the sample suction and discharge unit 3 in the horizontal direction by controlling the horizontal direction moving mechanism 4. Further, the control unit 6 is configured to move the sample container holding unit 2 and the sample suction and discharge unit 3 independently in the vertical direction by controlling the vertical direction moving mechanism 5. Further, the control unit 6 is configured to perform control to determine the state of the container suction member 20 described later. The control unit 6 includes, for example, a CPU (Central Processing Unit), a ROM (Read Only Memory), a RAM (Random Access Memory), and the like. The details of the control in which the control unit 6 determines the state of the container suction member 20 will be described later.

The control unit 6 includes the holding determination unit 8. The holding determination unit 8 is configured to determine whether the sample container holding unit 2 is holding the sample container 10. In the first embodiment, it is configured such that the control unit 6 functions as a holding determination unit 8 by executing a program stored in the storage unit 14. The detailed configuration for determining whether the sample container holding unit 2 is holding the sample container 10 by the holding determination unit 8 will be described later.

The negative pressure measurement unit 9 is provided in the tubular member 7 connecting the negative pressure supply unit 1 and the sample container holding unit 2, and is configured to measure the negative pressure in the sample container holding unit 2. The negative pressure supply unit 1 includes, for example, a pressure sensor.

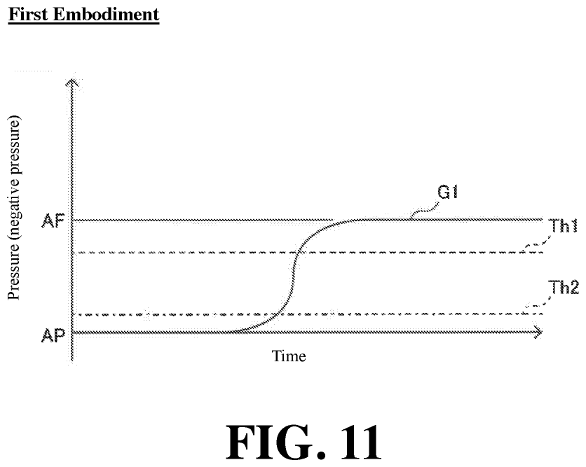

The storage unit 14 is storing a program that the control unit 6 executes. The storage unit 14 is storing a first threshold value Th1 (see FIG. 11) and a second threshold value Th2 (see FIG. 11) that are used when the control unit 6 performs control to determine the state of the container suction member 20. The second threshold value Th2 is also used to determine whether the holding determination unit 8 is holding the sample container 10. The storage unit 14 is configured to store the determination result 21 of the control unit 6. The storage unit 14 includes, for example, a non-volatile memory or a HDD (Hard Disk Drive).

The notification unit 16 is configured to notify the determination result 21 of the holding determination unit 8. Further, the notification unit 16 is configured to notify a negative pressure state of the container suction member 20 described later. The notification unit 16 may have any configuration as long as it can notify the determination result 21 of the holding determination unit 8 and the negative pressure state of the container suction member 20. In the first embodiment, the notification unit 16 includes, for example, a light source configured to emit different colors depending on the negative pressure state. The detailed configuration in which the notification unit 16 notifies the determination result 21 of the holding determination unit 8 and the negative pressure state of the container suction member 20 will be described later.

The preprocessing unit 60 is configured to perform preprocessing of a sample to be analyzed by a chromatography apparatus CE. The preprocessing unit 60 is configured to perform, for example, heating processing on a sample as preprocessing. The preprocessing unit 60 includes, for example, a sample heating device. The preprocessing unit 60 may be configured to include a sample stirring device and perform agitation processing of a sample as preprocessing.

### Horizontal Direction Moving Mechanism

Next, with reference to FIG. 2, the configuration of the horizontal direction moving mechanism 4 in the first embodiment will be described.

As shown in FIG. 2, the horizontal direction moving mechanism 4 includes a first direction moving mechanism 4a and a second direction moving mechanism 4b.

In the first embodiment, the first direction is denoted as an X-direction. Of the X-directions, one is denoted as an X1-direction and the other is denoted as an X2-direction. In the example shown in FIG. 2, in the second direction moving mechanism 4b, the direction on the side where the sample container holding unit 2 is provided is denoted as an X1-direction. Further, in the second direction moving mechanism 4b, the direction on the side where the sample suction and discharge unit 3 is provided is denoted as an X2-direction. In the first embodiment, the second direction is denoted as a Y-direction. Of the Y-directions, one is denoted as a Y1-direction and the other is denoted as an Y2-direction. In the example shown in FIG. 2, the direction on the first direction moving mechanism 4a side in the second direction moving mechanism 4b is denoted as a Y1-direction, and the opposite direction is denoted as a Y2-direction. The X-direction and the Y-direction are directions orthogonal to each other in the horizontal plane.

The first direction moving mechanism 4a is configured to move the second direction moving mechanism 4b in the X-direction. Specifically, the first direction moving mechanism 4a holds one end side (Y1 side) of the second direction moving mechanism 4b. The first direction moving mechanism 4a is configured to move the second direction moving mechanism 4b in the X-direction by moving the second direction moving mechanism 4b on the first direction moving mechanism 4a. The first direction moving mechanism 4a includes a linear motion mechanism, such as, e.g., a ball screw mechanism and a rack and pinion mechanism.

The second direction moving mechanism 4b is configured to move the sample container holding unit 2 and the sample suction and discharge unit 3 in the Y-direction. Specifically, the second direction moving mechanism 4b is provided with the sample container holding unit 2 and the sample suction and discharge unit 3, and the second direction moving mechanism 4b is configured to move the sample container holding unit 2 and the sample suction and discharge unit 3 in the Y-direction. The second direction moving mechanism 4b includes a linear motion mechanism, such as, e.g., a ball screw mechanism and a rack and pinion mechanism.

In the example shown in FIG. 2, the sample container holding unit 2 is provided on the side (X1-direction side) of the second direction moving mechanism 4b where the first sample container placement portion 61 is disposed. Further, the sample suction and discharge unit 3 is provided on the side (X2-direction side) of the second direction moving mechanism 4b where the chromatography apparatus CE is arranged. That is, in the first embodiment, the sample container holding unit 2 and the sample suction and discharge unit 3 are arranged at different positions in the horizontal direction. Note that the first sample container placement portion 61 is an example of the “sample container placement portion” recited in claims.

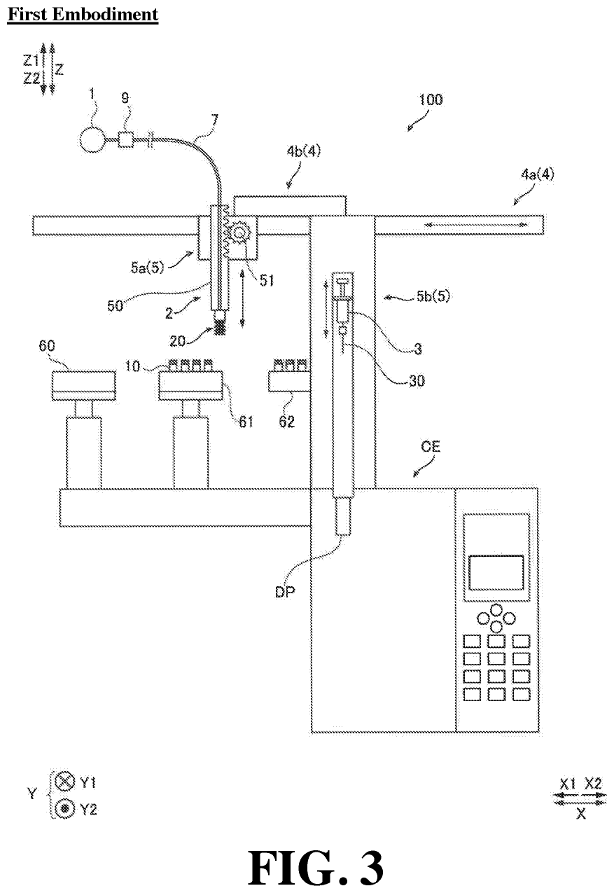

In the example shown in FIG. 2, the sample container holding unit 2 and the sample suction and discharge unit 3 are provided to the first direction moving mechanism 4a via the second direction moving mechanism 4b. Therefore, the sample container holding unit 2 and the sample suction and discharge unit 3 are integrally moved in the Y-direction by the second direction moving mechanism 4b, and are integrally moved in the X-direction by the first direction moving mechanism 4a. Thus, in the first embodiment, the horizontal direction moving mechanism 4 is configured to be able to move the sample container holding unit 2 and the sample suction and discharge unit 3 in the XY plane. The horizontal direction moving mechanism 4 is configured to be able to move the sample container holding unit 2 at least from the position of the second sample container placement portion 62 (see FIG. 3) to the position of the preprocessing unit 60. Further, the horizontal direction moving mechanism 4 is configured to be able to move the sample suction and discharge unit 3 at least from the position of the first sample container placement portion 61 to the position of the sample inlet port DP of the chromatography apparatus CE.

### Vertical Direction Moving Mechanism

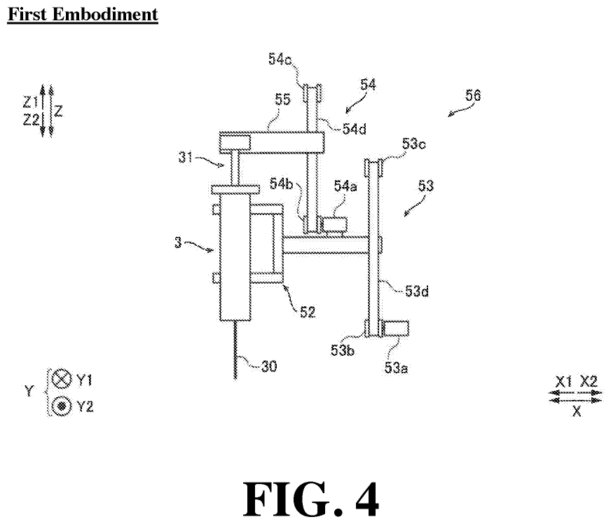

Next, with reference to FIG. 3 and FIG. 4, the configuration of the vertical direction moving mechanism 5 according to the first embodiment will be described. In the first embodiment, the direction along which the sample container holding unit 2 and the sample suction and discharge unit 3 are moved by the vertical direction moving mechanism 5 is denoted as a Z-direction. Of the Z-directions, the direction on the side of the horizontal direction moving mechanism 4 in the vertical direction moving mechanism 5 is denoted as a Z1-direction. Further, a direction opposite to the Z1-direction is denoted as a Z2-direction.

As shown in FIG. 3, the vertical direction moving mechanism 5 includes a first vertical direction moving mechanism 5a and a second vertical direction moving mechanism 5b. The first vertical direction moving mechanism 5a is configured to move the sample container holding unit 2 in the vertical direction. The second vertical direction moving mechanism 5b is configured to move the sample suction and discharge unit 3 in the vertical direction. Therefore, the vertical direction moving mechanism 5 is configured to be able to move the sample container holding unit 2 and the sample suction and discharge unit 3 independently in the vertical direction.

The first vertical direction moving mechanism 5a includes a sample container holding unit installation unit 50 and a drive unit 51. As an example, in FIG. 3, a sample container holding unit 2 is provided on one end side (Z2-direction side) of the sample container holding unit installation unit 50, and a rack (groove) is formed on the other end side (Z1-direction side). The first vertical direction moving mechanism 5a is configured to move the sample container holding unit installation unit 50 in the vertical direction by rotating a pinion engaged with the rack by the drive unit 51. The first vertical direction moving mechanism 5a is a so-called rack and pinion mechanism.

FIG. 4 is a schematic diagram of the second vertical direction moving mechanism 5b as viewed in the Y-direction. As shown in FIG. 4, the second vertical direction moving mechanism 5b includes a support portion 52, a support portion moving mechanism 53, and a plunger moving mechanism 54.

The support portion 52 is provided to the support portion moving mechanism 53, and is configured to hold the sample suction and discharge unit 3.

The support portion moving mechanism 53 is configured to move the support portion 52 in the vertical direction (Z-direction). The support portion moving mechanism 53 includes a first motor 53a, a first pulley 53b, a second pulley 53c, and a first belt 53d provided on the first pulley 53b and the second pulley 53c. The support portion 52 is provided to the first belt 53d, and the support portion 52 is moved in the vertical direction by moving the first belt 53d in accordance with the rotation of the first motor 53a. That is, the support portion moving mechanism 53 is configured to move the sample suction and discharge unit 3 in the vertical direction by moving the support portion 52 in the vertical direction in accordance with the rotation of the first motor 53a. The support portion moving mechanism 53 is a so-called belt and pulley mechanism.

### Configuration in Which the Sample Suction and Discharge Unit Suctions and Discharges a Sample

The sample suction and discharge unit 3 is provided with a needle 30 and a plunger 31. The plunger 31 is fitted in the sample suction and discharge unit 3, and is configured to suction and discharge the sample by moving the plunger 31 provided in the sample suction and discharge unit 3 in the up-and-down direction by the plunger moving mechanism 54.

The plunger moving mechanism 54 includes a second motor 54a, a third pulley 54b, a fourth pulley 54c, and a second belt 54d provided on the third pulley 54b and the fourth pulley 54c. The second belt 54d is provided with a plunger holding portion 55, and the second belt 54d is moved in accordance with the rotation of the second motor 54a to move the plunger holding portion 55 in the vertical direction to thereby move the plunger 31 in the vertical direction. The plunger moving mechanism 54 is a so-called belt and pulley mechanism.

When the plunger 31 is moved upward by the plunger moving mechanism 54, the sample is suctioned into the sample suction and discharge unit 3 through the needle 30. When the plunger 31 is moved downward by the plunger moving mechanism 54 after sample suction, the sample in the sample suction and discharge unit 3 is discharged through the needle 30.

Further, the plunger moving mechanism 54 is provided to the support portion 52 and moves integrally with the support portion 52. That is, the support portion moving mechanism 53 is configured to control the vertical position of the needle 30, and the plunger moving mechanism 54 is configured to control suction and discharge of the sample.

In the first embodiment, the sample suction and discharge unit 3 is configured to suction the sample to be analyzed by the chromatography apparatus CE from the sample container 10 and discharge the sample to the sample inlet port DP of the chromatography apparatus CE.

Specifically, by moving the sample container holding unit 2 in the horizontal direction and the vertical direction by the horizontal direction moving mechanism 4 and the vertical direction moving mechanism 5, the sample container 10 is moved from the first sample container placement portion 61 to the preprocessing unit 60 to perform sample preprocessing. Further, the sample container 10 after preprocessing is moved to the second sample container placement portion 62 (see FIG. 3) by the horizontal direction moving mechanism 4 and the vertical direction moving mechanism 5. Further, the sample suction and discharge unit 3 is moved by the horizontal direction moving mechanism 4 and the vertical direction moving mechanism 5 to the second sample container placement portion 62 where the sample container 10 is placed, suctions the sample after preprocessing in the sample container 10, and discharges the sample to the sample inlet port DP of the chromatography apparatus CE.

### Configuration of Sample Container

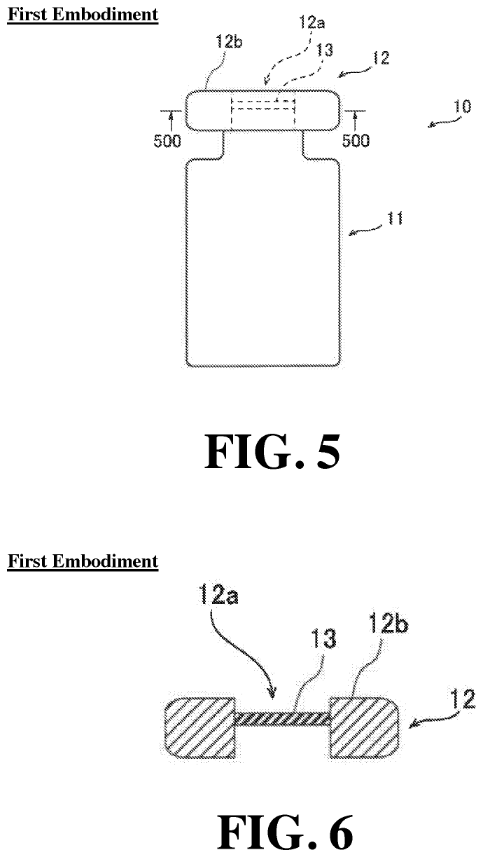

Next, with reference to FIG. 5 to FIG. 7, the structure of the sample container 10 will be described.

As shown in FIG. 5, the sample container 10 is configured by a container portion 11 and a lid portion 12. In the container portion 11, a sample to be analyzed is stored. The container portion 11 has an opening portion at one end side, and is formed in a tubular (cylindrical) shape in which the other end side is closed. The container portion 11 is made of, for example, resin or glass. The lid portion 12 seals the container portion 11 by closing the opening portion of the container portion 11. The sample container 10 is configured to be able to suction the sample inside the sample container by the needle 30 without opening the lid portion 12.

Specifically, the lid portion 12 is provided with a needle penetration portion 13 through which the needle 30 is pierced when the sample suction and discharge unit 3 suctions the sample. More specifically, the lid portion 12 is provided with a through-hole 12a, and the needle penetration portion 13 is provided so as to close the through-hole 12a. When the sample contained in the sample container 10 is suctioned, the needle 30 pierces through the needle penetration portion 13 to reach the sample in the container portion 11. The needle penetration portion 13 is made of a material capable of sealing the inside of the sample container 10 even after the sample is suctioned by the sample suction and discharge unit 3. The needle penetration portion 13 is made of, for example, a flexible material such as rubber.

The needle penetration portion 13 may be provided at any height as long as it is positioned within the through-hole 12a. In the first embodiment, as shown in FIG. 6, the needle penetration portion 13 is provided at a position slightly recessed from the upper surface portion 12b of the lid portion 12 in the through-hole 12a.

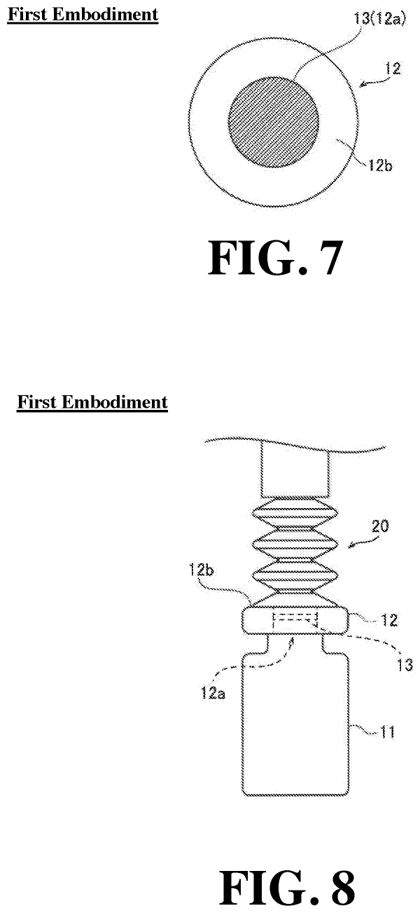

Note that the needle penetration portion 13 may be provided at any position of the lid portion 12. In the first embodiment, as shown in FIG. 7, the needle penetration portion 13 is provided, for example, on the inner peripheral side of the lid portion 12.

FIG. 8 is a schematic diagram showing the state in which the container suction member 20 and the sample container 10 are in contact with each other when the sample container holding unit 2 holds the sample container 10.

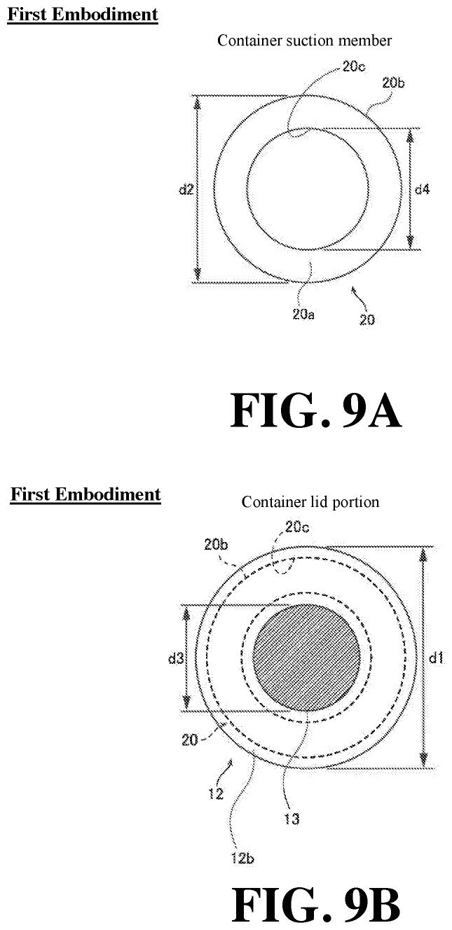

As shown in FIG. 8, the sample container holding unit 2 has a container suction member 20 that comes into contact with the lid portion 12 of the sample container 10. The container suction member 20 is provided exchangeably to the sample container holding unit 2. Further, the container suction member 20 is configured to bring the upper surface portion 12b of the lid portion 12 into close contact with the lower surface (contact surface 20a (see FIG. 9A)) of the container suction member 20 to form a substantially sealed area inside the container suction member 20 to thereby suction the sample container 10 by the supplied negative pressure. Further, the container suction member 20 has a cylindrical shape. The container suction member 20 includes, for example, a vacuum pad.

In the first embodiment, when the sample container 10 is held by the sample container holding unit 2, it is configured to bring the container suction member 20 into contact with the upper surface portion 12b of the lid portion 12. Specifically, the container suction member 20 is configured to come into contact with the lid portion 12 without coming into contact with the needle penetration portion 13 provided in the lid portion 12 through which the needle 30 is pierced when the sample suction and discharge unit 3 suctions the sample.

FIG. 9A is a schematic diagram of the contact surface 20a of the container suction member 20. FIG. 9B is a schematic diagram of the lid portion 12 as viewed from above.

In the first embodiment, the container suction member 20 is configured to come into contact with the lid portion 12 on the outer circumferential side than the needle penetration portion 13 provided on the inner circumferential side of the lid portion 12. Specifically, as shown in FIG. 9A and FIG. 9B, the outer periphery 20b of the container suction member 20 has a diameter d2 smaller than the diameter d1 of the lid portion 12. The inner periphery 20c of the container suction member 20 has a diameter d4 larger than the diameter d3 of the needle penetration portion 13. Therefore, the container suction member 20 comes into contact with the lid portion 12 without coming into contact with the needle penetration portion 13 on the outer circumferential side than the needle penetration portion 13 provided on the inner circumferential side of the lid portion 12. Further, the area of the contact surface 20a of the container suction member 20 is smaller than the area of the upper surface portion 12b of the lid portion 12 excluding the needle penetration portion 13.

### Transfer of Sample Container

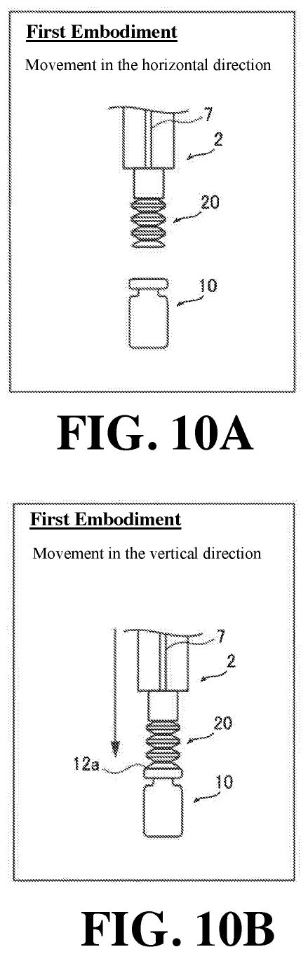

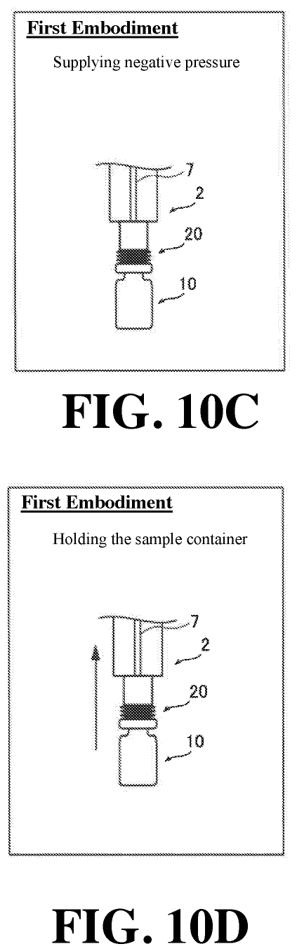

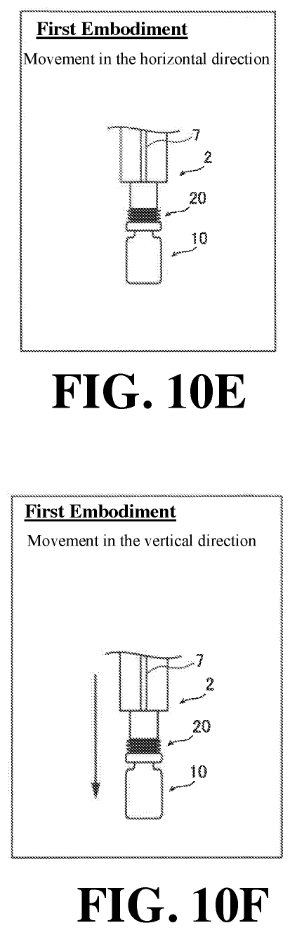

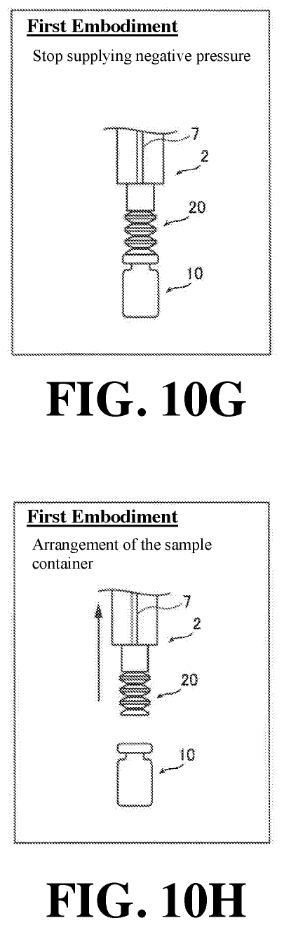

FIG. 10 is a schematic diagram showing the flow of processing when the sample transfer device 100 transfers the sample container 10.

As shown in FIG. 10A, the control unit 6 controls the horizontal direction moving mechanism 4 to move the sample container holding unit 2 to the position of the first sample container placement portion 61 where the sample container 10 is arranged. Thereafter, as shown in FIG. 10B, the control unit 6 controls the vertical direction moving mechanism 5 to move the sample container holding unit 2 in the vertical direction to a height at which the container suction member 20 comes into contact with the upper surface portion 12b of the lid portion 12 of the sample container 10. As shown in FIG. 10C, in a state in which the container suction member 20 and the upper surface portion 12b of the lid portion 12 are in contact with each other, the control unit 6 controls the negative pressure supply unit 1 to supply the negative pressure to the sample container holding unit 2. By supplying the negative pressure, the sample container holding unit 2 holds the sample container 10 as shown in FIG. 10D.

After the sample container holding unit 2 holds the sample container 10, as shown in FIG. 10E, the control unit 6 controls the horizontal direction moving mechanism 4 to move the sample container holding unit 2 to the position of the preprocessing unit 60. As shown in FIG. 10F, after moving the sample container 10 to the position of the preprocessing unit 60, the control unit 6 controls the vertical direction moving mechanism 5 to move the sample container 10 to the height to be disposed to the preprocessing unit 60. As shown in FIG. 10G, the control unit 6 controls the negative pressure supply unit 1 to stop the supply of the negative pressure from the negative pressure supply unit 1 to the sample container holding unit 2. As shown in FIG. 10H, the control unit 6 controls the vertical direction moving mechanism 5 to move the sample container holding unit 2 in the vertical direction, thereby completing the movement of the sample container 10.

Note that the configuration for moving the sample container 10 from the position of the preprocessing unit 60 to the position of the second sample container placement portion 62 is the same as the configuration for moving the sample container 10 from the position of the first sample container placement portion 61 to the position of the preprocessing unit 60.

### Determination by the Holding Determination Unit

FIG. 11 is a graph G1 showing changes in the negative pressure in the sample container holding unit 2 measured by the negative pressure measurement unit 9. The horizontal axis of the graph G1 denotes time, and the vertical axis thereof denotes pressure. In the following description, negative pressure denotes negative (minus) pressure difference from the atmospheric pressure AP, and magnitude of the negative pressure denotes a difference value (absolute value) between the measured pressure value of the negative pressure measurement unit 9 and the atmospheric pressure AP.

When the negative pressure is not supplied by the negative pressure supply unit 1, the pressure on the sample container holding unit 2 becomes the same value as the atmospheric pressure AP. When holding the sample container 10 by the sample container holding unit 2, the negative pressure is supplied by the negative pressure supply unit 1, so that the negative pressure (pressure) in the sample container holding unit 2 increases. In the first embodiment, a predetermined negative pressure capable of holding the sample container 10 by the sample container holding unit 2 is supplied from the negative pressure supply unit 1. Therefore, when the sample container holding unit 2 holds the sample container 10, the value of the graph G1 becomes approximately constant at the predetermined pressure value AF.

In the graph G1, the first threshold value Th1 is a value (pressure value) used to determine whether the sample container holding unit 2 is being able to hold the sample container 10 with a predetermined holding force. Also, the second threshold value Th2 is a value (pressure value) used to determine whether the sample container holding unit 2 is being able to hold the sample container 10.

The first threshold value Th1 and the second threshold value Th2 are determined based on the size of the inner diameter of the tubular member 7, the length of the tubular member 7 connecting the negative pressure supply unit 1 and the sample container holding unit 2, and the shape of the container suction member 20. Here, since the size of the inner diameter of the tubular member 7 and the length of the tubular member 7 connecting the negative pressure supply unit 1 and the sample container holding unit 2 are known values in design, the first threshold value Th1 and the second threshold value Th2 are determined based on the size of the container suction member 20 to be used.

Note that the size of the container suction member 20 denotes the area of the contact surface 20a. The size of the container suction member 20 to be used may be stored in advance in the storage unit 14 by the user or the like. Further, it may be configured such that an IC chip or an RF tag (electronic tag) is attached to the container suction member 20 and a sensor for reading the IC chip or the like is provided to the sample transfer device 100 to acquire the size of the container suction member 20 to be used. Alternatively, the size of the container suction member 20 to be used may be recognized by a reflection sensor, a magnetic sensor or the like, or the size of the container suction member 20 to be used may be recognized by a mechanical switch. Any configuration may be used as long as the size of the container suction member 20 to be used can be acquired.

In the first embodiment, the holding determination unit 8 is configured to determine whether the sample container holding unit 2 is holding the sample container 10 based on the magnitude of the negative pressure in the sample container holding unit 2. Specifically, the holding determination unit 8 determines whether the sample container holding unit 2 is holding the sample container 10 based on whether the magnitude of the negative pressure in the sample container holding unit 2 is equal to or greater than the second threshold value Th2. That is, the holding determination unit 8 determines that the sample container holding unit 2 is holding the sample container 10 when the magnitude of the negative pressure in sample container holding unit 2 is equal to or greater than the second threshold value Th2. Further, the holding determination unit 8 determines that the sample container holding unit 2 is not being able to hold the sample container 10 when the magnitude of the negative pressure in the sample container holding unit 2 is smaller than the second threshold value Th2. Note that since the negative pressure supplied from the negative pressure supply unit 1 is changed according to the shape of the container suction member 20, the value of the second threshold value Th2 used by the holding determination unit 8 for the determination is changed according to the shape of the container suction member 20.

The notification unit 16 is configured to notify the determination result 21 of the holding determination unit 8. In the first embodiment, the notification unit 16 is configured to emit lights different in color according to, for example, the determination result 21 of the holding determination unit 8.

In the first embodiment, the notification unit 16 is configured to emit blue light when the sample container holding unit 2 is being able to hold the sample container 10. Further, the notification unit 16 is configured to emit red light when the sample container holding unit 2 cannot hold the sample container 10.

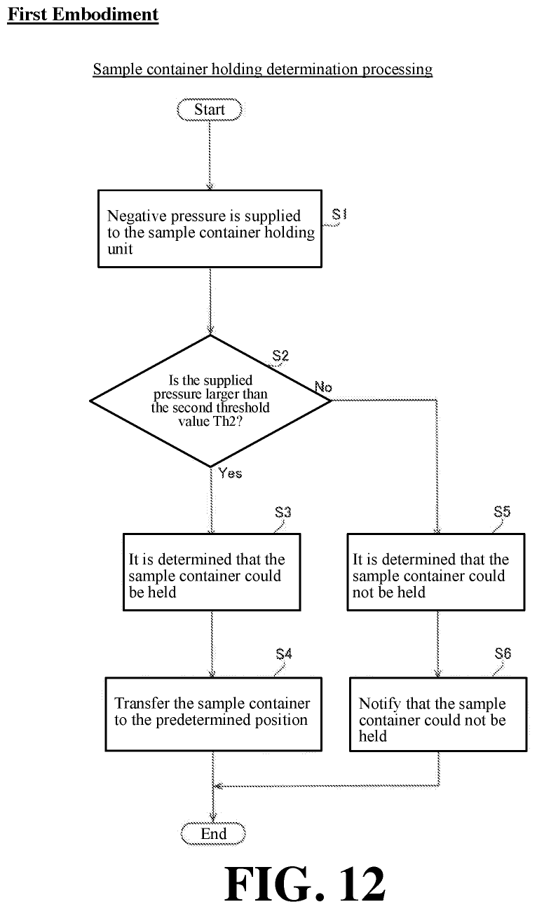

Next, with reference to FIG. 12, in the sample transfer device 100 according to the first embodiment, the flow of the method that the holding determination unit 8 determines whether the sample container holding unit 2 is holding the sample container 10 will be described.

In Step S1, the negative pressure supply unit 1 supplies negative pressure to the sample container holding unit 2 under the control of the control unit 6. Thereafter, in Step S2, the holding determination unit 8 determines whether the negative pressure in the sample container holding unit 2 is larger than the second threshold value Th2. When the negative pressure in the sample container holding unit 2 is larger than the second threshold value Th2, the processing proceeds to Step S3. When the negative pressure in the sample container holding unit 2 has not become a value larger than the second threshold value Th2, the processing proceeds to Step S5.

In step S3, the holding determination unit 8 determines that the sample container holding unit 2 could hold the sample container 10. Thereafter, the processing proceeds to Step S4.

In Step S4, the control unit 6 controls the horizontal direction moving mechanism 4 and the vertical direction moving mechanism 5 to transfer the sample container 10 to a predetermined position, and ends the processing. In Step S4, the control unit 6 may control the notification unit 16 to notify that the sample container holding unit 2 could hold the sample container 10.

In Step S5, the holding determination unit 8 determines that the sample container holding unit 2 could not hold the sample container 10. Thereafter, in Step S6, the control unit 6 controls the notification unit 16 to notify that the sample container holding unit 2 could not hold the sample container 10. Further, the control unit 6 controls the horizontal direction moving mechanism 4 and the vertical direction moving mechanism 5 to stop the transfer of the sample container 10, and ends the processing.

### Determination of Negative Pressure State

Next, with reference to FIG. 11, the configuration for performing the determination processing of the negative pressure state by the control unit 6 will be described.

The control unit 6 is configured to perform control to determine the state of the container suction member 20 based on a predetermined pressure value determined based on the size of the container suction member 20 and the magnitude of the negative pressure in the container suction member 20. Specifically, the control unit 6 is configured to perform control to distinguishably determine whether the container suction member 20 has deteriorated or the shape of the container suction member 20 is mismatched with respect to the lid portion 12 of the sample container 10 based on the magnitude of the negative pressure. More specifically, the control unit 6 is configured to perform control to distinguishably determine whether the container suction member 20 has deteriorated or the shape of the container suction member 20 is mismatched with respect to the lid portion 12 of the sample container 10, based on the time series detection result of the negative pressure.

As the transfer operation is repeated, the container suction member 20 deteriorates, which results in the deterioration of the degree of sealing between the upper surface portion 12b of the lid portion 12 and the container suction member 20. Therefore, the control unit 6 is configured to perform control to determine that the container suction member 20 has deteriorated based on the magnitude of the negative pressure supplied to the container suction member 20, the first threshold value Th1, and the second threshold value Th2 smaller than the first threshold value Th1 when the negative pressure has changed in time series from the first negative pressure state in which the negative pressure is greater than the first threshold value Th1 to a third negative pressure state in which the negative pressure is equal to or smaller than the second threshold value Th2 via the second negative pressure state in which the negative pressure is equal to or is smaller than the first threshold value Th1 and greater than the second threshold value Th2. Note that the negative pressure supplied from the negative pressure supply unit 1 is changed according to the shape of the container suction member 20, therefore the value of the first threshold value Th1 and the value of the second threshold value Th2 used by the control unit 6 for determination change according to the shape of the container suction member 20.

Further, the control unit 6 is configured to perform control to determine that the shape of the container suction member 20 is mismatched with respect to the lid portion 12 of the sample container 10 based on the magnitude of the negative pressure supplied to the container suction member 20, the first threshold value Th1, and the second threshold value Th2 smaller than the first threshold value Th1 when the negative pressure has become to the second negative pressure state in which the negative pressure is equal to or smaller than the first threshold value Th1 and larger than the second threshold value Th2 or to a third negative pressure state in which the negative pressure is equal to or smaller than the second threshold value Th2 without becoming the first negative pressure state in which the negative pressure is larger than the first threshold value Th1.

The first negative pressure state is a state in which a predetermined negative pressure is supplied to the container suction member 20 so that the sample container holding unit 2 can normally hold the sample container 10. The second negative pressure state is a state in which the container suction member 20 has deteriorated, so that the sample container holding unit 2 can hold the sample container 10 but the holding force is lower than that in the normal state (first negative pressure state). Further, the third negative pressure state is a state in which the container suction member 20 has further deteriorated than in the second negative pressure state, so that the sample container 10 cannot be held by the sample container holding unit 2.

The notification unit 16 is configured to notify the negative pressure state of the container suction member 20. In the first embodiment, the notification unit 16 is configured to emit blue light, for example, when the negative pressure state of the container suction member 20 is the first negative pressure state. Further, the notification unit 16 is configured to emit yellow light, for example, when the negative pressure state of the container suction member 20 is the second negative pressure state. Further, the notification unit 16 is configured to emit red light, for example, when the negative pressure state of the container suction member 20 is the third negative pressure state.

In other words, when the sample container holding unit 2 is being able to hold the sample container 10 normally (in the case of the first negative pressure state), the notification unit 16 notifies that the sample container 10 is being able to be normally held by emitting blue light. Further, when the sample container 10 is being able to be held by the sample container holding unit 2 but the holding force is reduced as compared with the normal state (in the case of the second negative pressure state), the notification unit 16 notifies the reduction of the holding force by emitting yellow light. Further, when the sample container 10 is not being able to be held by the sample container holding unit 2 or there is a possibility that the sample container 10 has dropped from the sample container holding unit 2 (in the case of the third negative pressure state), the notification unit 16 notifies that the sample container holding unit 2 cannot hold the sample container 10 or there is a possibility that the sample container 10 has dropped from the sample container holding unit 2 by emitting red light.

The notification unit 16 may be configured by a means other than a light source that emits lights different in color. For example, the notification unit 16 may be configured to notify the negative pressure state of the container suction member 20 by displaying different messages on the display unit or the like according to the negative pressure state of the container suction member 20.

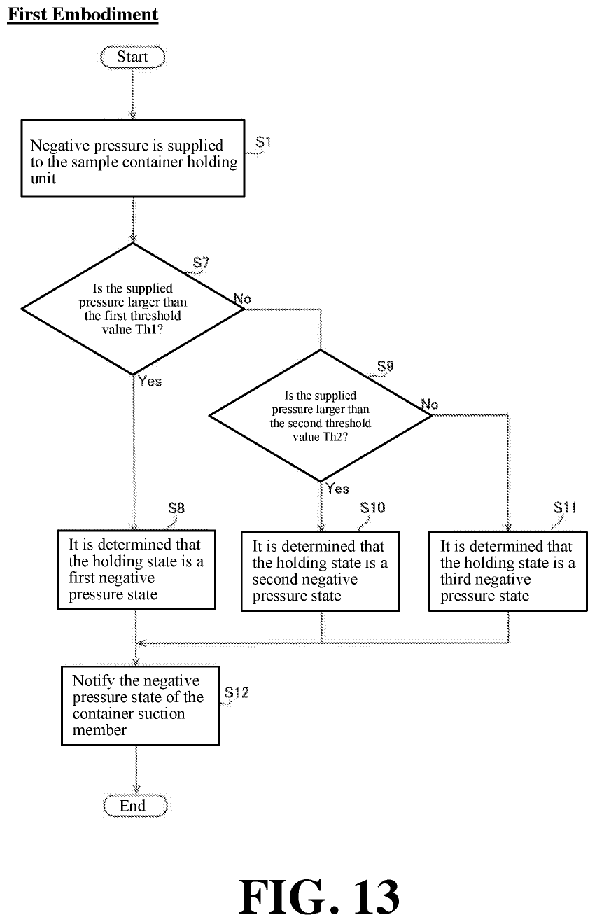

Next, with reference to FIG. 13, the flow of the method of determining the negative pressure state of the container suction member 20 by the control unit 6 in the sample transfer device 100 according to the first embodiment will be described. As for the same processing as that of the holding determination processing by the holding determination unit 8 shown in FIG. 12, the description will be omitted by allotting the same reference numerals.

In Step S1, the control unit 6 makes the negative pressure supply unit 1 supply the negative pressure to the sample container holding unit 2. Thereafter, in Step S7, the control unit 6 determines whether the negative pressure supplied to the sample container holding unit 2 is larger than the first threshold value Th1. When the negative pressure supplied to the sample container holding unit 2 is larger than the first threshold value Th1, the processing proceeds to Step S8. When the negative pressure supplied to the sample container holding unit 2 is equal to or smaller than the first threshold value Th1, the processing proceeds to Step S9.

In Step S8, the control unit 6 determines that the negative pressure state of the container suction member 20 is the first negative pressure state. Thereafter, the processing proceeds to Step S12.

In Step S9, the control unit 6 determines whether the negative pressure supplied to the sample container holding unit 2 is larger than the second threshold value Th2. When the negative pressure supplied to the sample container holding unit 2 is larger than the second threshold value Th2, the processing proceeds to Step S10. When the negative pressure supplied to the sample container holding unit 2 is equal to or smaller than the second threshold value Th2, the processing proceeds to Step S11.

In Step S10, the control unit 6 determines that the negative pressure state of the container suction member 20 is the second negative pressure state. Thereafter, the processing proceeds to Step S12.

In Step S11, the control unit 6 determines that the negative pressure state of the container suction member 20 is the third negative pressure state. Thereafter, the processing proceeds to Step S12.

In Step S12, the control unit 6 controls the notification unit 16 to notify the negative pressure state of the container suction member 20, and ends the processing.

### Effects of First Embodiment

In the first embodiment, the following effects can be obtained.

In the first embodiment, as described above, the sample transfer device 100 is provided with the negative pressure supply unit 1 configured to supply negative pressure, the sample container holding unit 2 configured to hold the sample container 10, the container suction member 20 which is provided exchangeably to the sample container holding unit 2 and is configured to suction the sample container 10 by the supplied negative pressure, and the control unit 6 configured to perform control to determine the state of the container suction member 20 based on the predetermined pressure value determined based on the size of the container suction member 20 and the magnitude of the negative pressure in the container suction member 20.

With this, since the magnitude of the negative pressure in the container suction member 20 changes depending on the state of the container suction member 20, it is possible to determine whether the container suction member 20 can suction the sample container 10, so that it is possible to determine whether it is necessary to replace the container suction member 20. As a result, before the sample container holding unit 2 becomes the state in which it cannot hold the sample container 10 normally, it is possible to grasp the replacement time of the container suction member 20.

Further, in the first embodiment, as described above, the control unit 6 is configured to perform control to distinguishably determine whether the container suction member 20 has deteriorated or the shape of the container suction member 20 is mismatched with respect to the lid portion 12 of the sample container 10 based on the magnitude of the negative pressure.

With this, it is possible to grasp the cause that the sample container holding unit 2 becomes a state in which it cannot hold the sample container 10 normally is due to the fact that the container suction member 20 has deteriorated or the shape of the container suction member 20 is mismatched with respect to the lid portion 12 of the sample container 10. As a result, when exchanging the container suction member 20, it is possible to determine whether it should be replaced with a container suction member 20 that has the same size, etc., as the container suction member 20 before the replacement and that has not deteriorated or it should be replaced with a container suction member 20 having a size, etc., different from the container suction member 20 before the replacement.

Further, in the first embodiment, as described above, the storage unit 14 for storing the determination result 21 of the control unit 6 is further provided. The control unit 6 is configured to perform control to distinguishably determine whether the container suction member 20 has deteriorated or the shape of the container suction member 20 is mismatched with respect to the lid portion 12 of the sample container 10 based on the time series detection result of the negative pressure.

With this, depending on whether the magnitude of the negative pressure in the container suction member 20 gradually decreased (over time) or the magnitude of the negative pressure in the container suction member 20 suddenly decreased, e.g., after replacing the container suction member 20, it is possible to accurately determine the cause that the sample container holding unit 2 became unable to properly hold the sample container 10. As a result, compared with the configuration in which the state of the container suction member 20 is determined based only on the negative pressure detection result at a certain time point, it becomes possible to more accurately determine the cause of the decrease in the holding power of the sample container holding unit 2 from the normal value. Thus, it can be accurately determined that it should be replaced with what kind of container suction member 20.

Further, in the first embodiment, as described above, the control unit 6 is configured to perform control to determine that the container suction member 20 has deteriorated based on the magnitude of the negative pressure supplied to the container suction member 20, the first threshold value Th1, and the second threshold value Th2 smaller than the first threshold value Th1 when the negative pressure has changed in time series from the first negative pressure state in which the negative pressure is greater than the first threshold value Th1 to a third negative pressure state in which the negative pressure is equal to or smaller than the second threshold value Th2 via the second negative pressure state in which the negative pressure equal to or smaller than the first threshold value Th1 and greater than the second threshold value Th2.

With this, when the pressure value in the container suction member 20 gradually decreases, it is possible to determine that the container suction member 20 has deteriorated, so that the deterioration state of the container suction member 20 can be grasped in detail. As a result, it becomes possible to grasp the deterioration status of the container suction member 20 in detail, which enables to grasp the appropriate replacement time of the container suction member 20.

Further, in the first embodiment, as described above, the control unit 6 is configured to perform control to determine that the shape of the container suction member 20 is mismatched with respect to the lid portion 12 of the sample container 10 based on the magnitude of the negative pressure supplied to the container suction member 20, the first threshold value Th1, and the second threshold value Th2 smaller than the first threshold value Th1 when the negative pressure has become to the second negative pressure state in which the negative pressure is equal to or smaller than the first threshold value Th1 and larger than the second threshold value Th2 or to a third negative pressure state in which the negative pressure is equal to or smaller than the second threshold value Th2 without becoming the first negative pressure state in which the negative pressure is larger than the first threshold value Th1.

With this, when the negative pressure state of the container suction member 20 has become the second negative pressure state or the third negative pressure state without passing through the first negative pressure state, it can be determined that the shape of the container suction member 20 is mismatched with respect to the lid portion 12 of the sample container 10, which in turn makes it possible to determine whether the cause that the sample container holding unit 2 cannot normally hold the sample container 10 is the mismatch of the shape of the container suction member 20 with respect to the lid portion 12 of the sample container 10. As a result, unlike the case where the container suction member 20 has deteriorated, the user can confirm whether the prompt replacement is necessary according to the negative pressure state of the container suction member 20.

Further, in the first embodiment, as described above, the device further includes a notification unit 16 configured to notify that the state of the container suction member 20 is which of the first negative pressure state, the second negative pressure state, and the third negative pressure state.

With this, the user can grasp the state of the container suction member 20 based on the notification content of the notification unit 16. As a result, for example, regardless of the environment in which the sample transfer device 100 is installed, it is possible to determine the replacement time based on the state of the container suction member 20, as compared with the case in which the container suction member 20 is exchanged based on the duration of use (used time) or the number of uses of the container suction member 20. Thus, the container suction members 20 can be replaced at the timing appropriate for the environment in which the sample transfer device 100 is installed.

Further, in the first embodiment, as described above, the device is further provided with the holding determination unit 8 configured to determine whether the sample container holding unit 2 is holding the sample container 10 based on the magnitude of the negative pressure supplied to the sample container holding unit 2.

With this, based on the magnitude of the negative pressure supplied to the sample container holding unit 2, it is possible to grasp whether the sample container holding unit 2 is holding the sample container 10. As a result, for example, as compared with the case in which the sample container 10 is held using a magnet or the like, it can be more accurately grasped whether the sample container 10 could be held. Further, based on the number of times that the sample container holding unit 2 failed to hold the sample container 10, it is possible to grasp whether the size of the sample container holding unit 2 or the like with respect to the sample container 10 is appropriate.

Further, in the first embodiment, as described above, the device is further provided with the sample suction and discharge unit 3 configured to suction the sample from the sample container 10 and discharge the sample at a predetermined position, the horizontal direction moving mechanism 4 configured to move the sample container holding unit 2 together with the sample suction and discharge unit 3 in the horizontal direction, and the vertical direction moving mechanism 5 configured to move the sample container holding unit 2 and the sample suction and discharge unit 3 independently in the vertical direction.

With this, it becomes possible to integrally move the sample suction and discharge unit 3 and the sample container holding unit 2, which in turn can simplify the device configuration and suppress the increase in size of the device. Further, by moving the sample container holding unit 2 and the sample suction and discharge unit 3 independently in the vertical direction, when holding the sample container 10 by the sample container holding unit 2, it is possible to suppress that the sample suction and discharge unit 3 comes into contact with other sample containers 10. Therefore, unlike the configuration in which the movement of the sample container holding unit 2 and the movement of the sample suction and discharge unit 3 in the vertical direction are integrally performed, there is no need to consider that the sample container holding unit 2 and the sample suction and discharge unit 3 interfere with each other. This enables to suppress complication of the device configuration. As a result, by grasping the state of the container suction member 20, it is possible to suppress the increase of the device and the complication of the device configuration in the sample transfer device 100 capable of grasping the appropriate replacement time of the container suction member 20.

Further, in the first embodiment, as described above, the preprocessing unit 60 configured to preprocess the sample to be analyzed by a chromatography apparatus CE is further provided. The horizontal direction moving mechanism 4 and the vertical direction moving mechanism 5 are configured to move the sample container 10 from the first sample container placement portion 61 to the preprocessing unit 60 by moving the sample container holding unit 2 and perform preprocessing of the sample. The sample suction and discharge unit 3 is configured to suction the sample after preprocessing and discharge the sample to the sample inlet port DP of the chromatography apparatus CE.

With this, it becomes possible to grasp the replacement time of the container suction member 20. Therefore, for example, when the sample container 10 is transferred to the preprocessing unit 60 and preprocessed and then the analysis is performed by the chromatography apparatus CE, it is possible to assuredly perform the sample preprocessing. As a result, when analyzing the sample subjected to preprocessing using the chromatography apparatus CE, it is preferable to use the sample transfer device 100.

### Second Embodiment

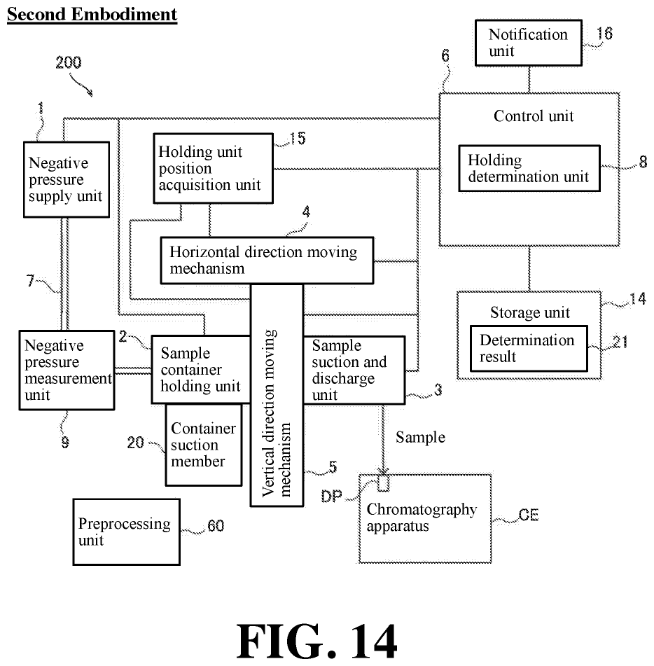

Next, with reference to FIG. 11 and FIG. 14, the sample transfer device 200 (see FIG. 14) according to the second embodiment will be described. Unlike the first embodiment in which the holding determination unit 8 determines the holding of the sample container 10, in the second embodiment, the sample transfer device 200 is provided with a holding unit position acquisition unit 15, and the holding determination unit 8 is configured to be able to determine whether the sample container 10 has been moved to a predetermined location. The same reference numeral is allotted to the same configuration as that of the first embodiment, and the description thereof will be omitted.

### Configuration of Sample Transfer Device

First, with reference to FIG. 14. the configuration of the sample transfer device 200 according to the second embodiment will be described.

In the second embodiment, in addition to the configuration of the sample transfer device 100 in the first embodiment, the sample transfer device 200 is provided with a holding unit position acquisition unit 15 configured to acquire the position of the sample container holding unit 2 in the horizontal direction. Further, in the second embodiment, the holding determination unit 8 is configured to be able to determine whether the sample container 10 has been moved to a predetermined location based on the position of the sample container holding unit 2 and the magnitude of the negative pressure in the sample container holding unit 2. Note that the predetermined place denotes the preprocessing unit 60 or the second sample container placement portion 62.

The holding unit position acquisition unit 15 may have any configuration as long as it can acquire the position of the sample container holding unit 2. In the second embodiment, the holding unit position acquisition unit 15 includes, for example, a sensor configured to acquire the position of the sample container holding unit 2 by the output of the motor provided in the horizontal direction moving mechanism 4.

### Movement Determination of the Sample Container

In the second embodiment, the holding determination unit 8 is configured to determine whether the sample container 10 could be transferred to the predetermined position depending on whether the negative pressure value supplied to the sample container holding unit 2 is larger than the second threshold value Th2 while transferring the sample container 10 by the horizontal direction moving mechanism 4 and the vertical direction moving mechanism 5.

Specifically, the holding determination unit 8 determines that the sample container 10 could be transferred to the predetermined position when the value of the negative pressure supplied to sample container holding unit 2 while transferring the sample container 10 is larger than the second threshold value Th2. Further, the holding determination unit 8 determines that the sample container 10 could not be transferred to the predetermined position when the value of the negative pressure supplied to the sample container holding unit 2 when transferring the sample container 10 is equal to or smaller than the second threshold value Th2.

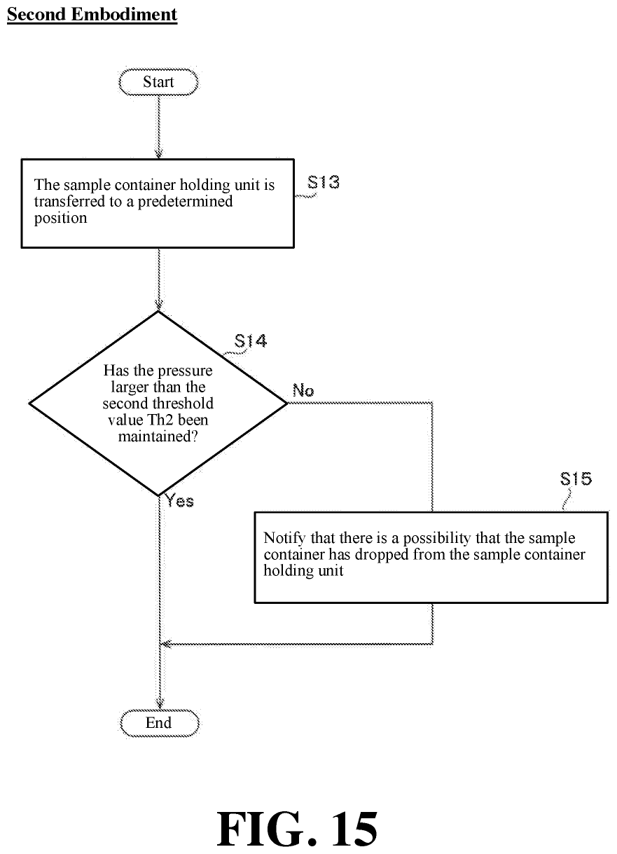

Next, with reference to FIG. 15, the flow of the method of determining whether the sample container 10 has been transferred to the predetermined position in the sample transfer device 200 according to the second embodiment will be described.

In Step S13, the horizontal direction moving mechanism 4 and the vertical direction moving mechanism 5 transfer the sample container 10 to a predetermined location (the preprocessing unit 60 or the second sample container placement portion 62) under the control of the control unit 6.

Next, in Step S14, the holding determination unit 8 determines whether the negative pressure in the sample container holding unit 2 was a value larger than the second threshold value Th2 when transferring the sample container 10 to the predetermined position. When the negative pressure in the sample container holding unit 2 was a value larger than the second threshold value Th2 when transferring the sample container 10 to the predetermined position, it is determined that the sample container 10 could have been transferred to the predetermined position, and the determination processing is ended. When the negative pressure in the sample container holding unit 2 was equal to or smaller than the second threshold value Th2 when transferring the sample container 10 to the predetermined position, the processing proceeds to Step S15.

When the sample container 10 could have been transferred to the predetermined position, the sample transfer device 200 continuously performs the subsequent processing. As the subsequent processing, for example, when the sample container 10 has been transferred from the first sample container placement portion 61 to the preprocessing unit 60, the control unit 6 controls the preprocessing unit 60 to perform preprocessing of the sample. Also, for example, when the sample container 10 has been transferred from the preprocessing unit 60 to the second sample container placement portion 62, the control unit 6 controls the horizontal direction moving mechanism 4 and the vertical direction moving mechanism 5 to move the sample suction and discharge unit 3 to the second sample container placement portion 62, suction the sample from the sample container 10, and discharge the sample to the sample inlet port DP of the chromatography apparatus CE to analyze the sample.

In Step S15, the holding determination unit 8 determines that the sample container 10 could not have been transferred to the predetermined position. Thereafter, the control unit 6 controls the notification unit 16 to notify that there is a possibility that the sample container 10 has dropped from the sample container holding unit 2 and ends the processing.

The other configurations of the second embodiment are the same as those of the first embodiment.

### Effects of Second Embodiment

In the second embodiment, the following effects can be obtained.

In the second embodiment, as described above, the holding unit position acquisition unit 15 for acquiring the position of container holding unit 2 in the horizontal direction is further provided. The holding determination unit 8 is configured to be able to determine whether the sample container 10 has been moved to the predetermined position based on the position of the sample container holding unit 2 and the magnitude of the negative pressure in the sample container holding unit 2.

With this, it is possible to grasp whether the sample container 10 has been moved to the predetermined position. Therefore, for example, when the sample container 10 has not been transferred to the predetermined position, for example, when the sample container 10 has dropped from the sample container holding unit 2 during the transferring, the suction of the sample by the sample suction and discharge unit 3 can be stopped. As a result, it becomes possible to suppress that the sample suction and discharge unit 3 cannot suction the sample because the sample container 10 has not been disposed at the predetermined position, which in turn can suppress the analysis in a state in which the sample has not been discharged to the analyzer or the like.

The other effects of the second embodiment are the same as those of the first embodiment.

### Modifications

It should be understood that the embodiments disclosed here are examples in all respects and are not restrictive. The scope of the present invention is shown by the scope of the claims rather than the descriptions of the embodiments described above, and includes all changes (modifications) within the meaning of equivalent and the scope of claims.

For example, in the first and second embodiments, a configuration example is shown in which the sample transfer device 100 (200) is provided with the vertical direction moving mechanism 5 for moving the sample container holding unit 2 and the sample suction and discharge unit 3 in the vertical direction, but the present invention is not limited to this. For example, as long as it is possible to move the first sample container placement portion 61 and the second sample container placement portion 62 in the vertical direction, the sample transfer device 100 (200) is not required to provide the vertical direction moving mechanism 5.

In the first and second embodiments, a configuration example is shown in which the sample transfer device 100 (200) is provided with the holding determination unit 8, but the present invention is not limited to this. For example, in the case of not performing the holding determination of the sample container 10 by the sample container holding unit 2, the sample transfer device 100 (200) is not required to provide the holding determination unit 8.

In the first and second embodiments, a configuration example is shown in which the sample container holding unit 2 and the sample suction and discharge unit 3 are arranged in different directions with respect to the second direction moving mechanism 4b in the X-direction, but the present invention is not limited to this. For example, the sample container holding unit 2 and the sample suction and discharge unit 3 may be arranged on the same direction side of the second direction moving mechanism 4b in the X-direction.

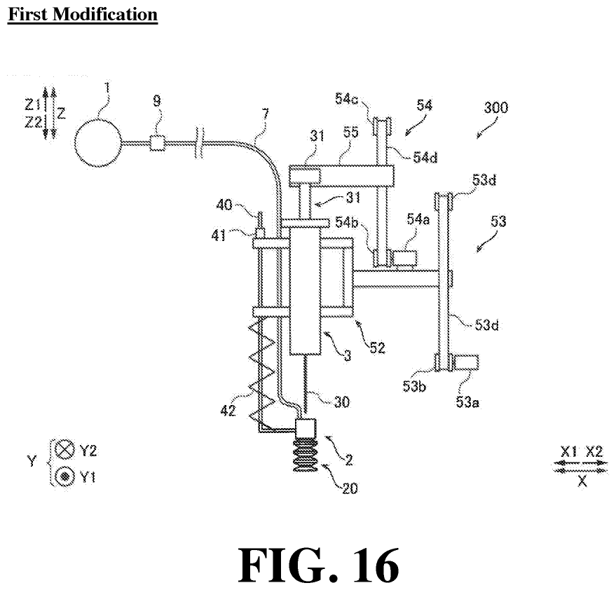

Further, in the above first and second embodiments, a configuration example is shown in which the vertical direction moving mechanism 5 moves the sample container holding unit 2 and the sample suction and discharge unit 3 independently in the vertical direction, but the present invention is not limited to this. For example, like the sample transfer device 300 shown in FIG. 16, the vertical direction moving mechanism 5 may be configured to integrally move the sample container holding unit 2 and the sample suction and discharge unit 3 in the vertical direction. In the case of the configuration in which the vertical direction moving mechanism 5 integrally moves the sample container holding unit 2 and the sample suction and discharge unit 3, the support portion 52 may be configured to support the sample container holding unit 2 and the sample suction and discharge unit 3.

Specifically, the support portion 52 is configured to support the support portion 40 provided with the sample container holding unit 2. Further, the support portion 40 is provided with a stopper 41 and a spring 42. When the sample suction and discharge unit 3 discharges the sample to the chromatography apparatus CE, it is configured such that the sample container holding unit 2 (container suction member 20) is relatively moved in the Z-direction with respect to the sample suction and discharge unit 3 by the stopper 41 and the spring 42, so that the needle 30 of the sample suction discharge unit 3 can be moved inside the sample container holding unit 2 (container suction member 20).

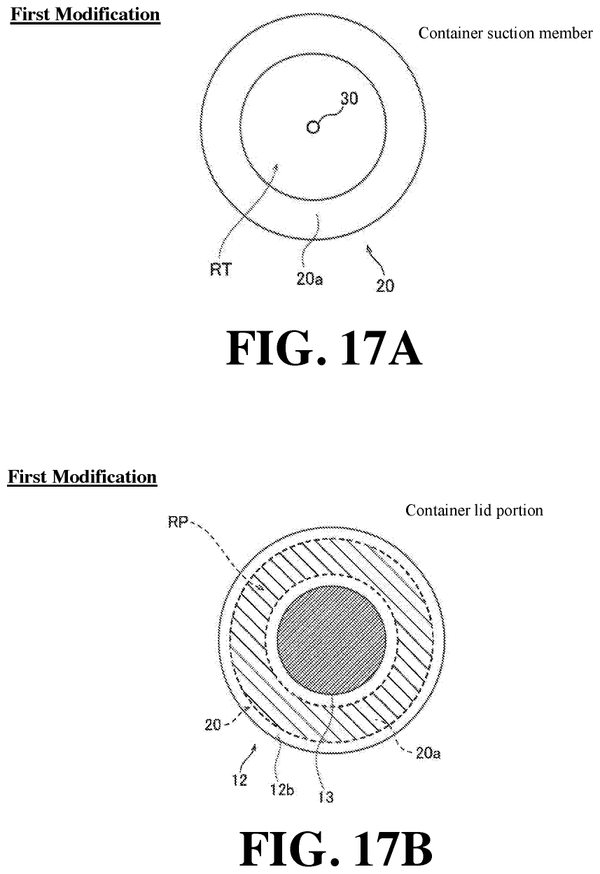

Specifically, as shown in FIG. 17A, the container suction member 20 may be configured to provide a region RT through which the needle 30 passes. By configuring as described above, in the case of the configuration in which the vertical direction moving mechanism 5 integrally moves the sample container holding unit 2 and the sample suction and discharge unit 3, the sample container holding unit 2 and the sample suction and discharge unit 3 can be coaxially arranged. Further, in the case of arranging the sample container holding unit 2 and the sample suction and discharge unit 3 coaxially, the container suction member 20 may be configured to hold the sample container 10 by supplying negative pressure to the hatched region RP of the container suction member 20 as shown in FIG. 17B.

Further, in the first and second embodiments, a configuration example is shown in which the sample suction and discharge unit 3 discharges the sample to the chromatography apparatus CE, the present invention is not limited to this. The apparatus in which the sample suction and discharge unit 3 discharges the sample is not limited to a chromatography apparatus CE. For example, the sample suction and discharge unit 3 may be configured to discharge the sample to an analyzer, such as, e.g., a mass spectrometer or a spectrometer. Further, the sample suction and discharge unit 3 may be configured to discharge the sample into a test tube, a plastic tube, or the like in order to adjust the sample to be analyzed.

Further, in the first and second embodiments, a configuration sample is shown in which the container holding unit 2 is provided with the lid portion 12 in which the needle penetration portion 13 is provided at a position recessed from the upper surface portion 12b of the lid portion 12, but the present invention is not limited to this. For example, the sample container holding unit 2 may be configured to hold the sample container 10 provided with the lid portion 12 in which the needle penetration portion 13 is provided so as to protrude from the upper surface portion 12b of the lid portion 12.

Further, in the first and second embodiments, a configuration example is shown in which the sample container holding unit 2 holds the sample container 10 provided with the lid portion 12 having the needle penetration portion 13, but the present invention is not limited to this. For example, the sample container holding unit 2 may be configured to hold the sample container 10 provided with the lid portion 12 not having the needle penetration portion 13. Further, the sample container holding unit 2 may be configured to hold not only the sample container 10 but also a test tube, a plastic tube, a well plate, a periodic replacement parts of a chromatography apparatus, etc.

Further, in the first and second embodiments, a configuration sample is shown in which the container suction member 20 is formed in a cylindrical shape, but the present invention is not limited to this. As long as the container suction member 20 can come into contact with the lid portion 12 without coming into contact with the needle penetration portion 13, the container suction member 20 may have any shape.

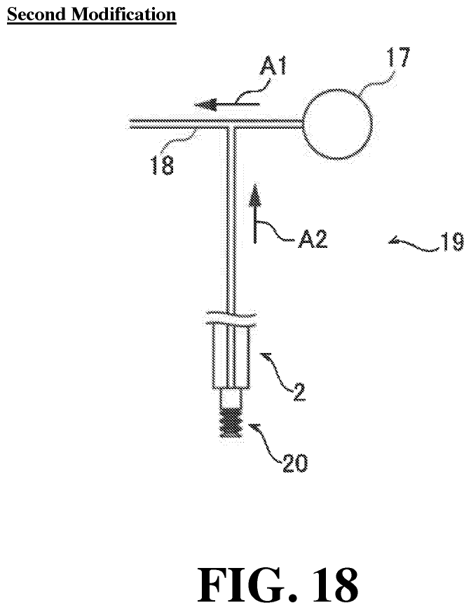

In the first and second embodiments, a configuration example is shown in which the negative pressure generated by being suctioned by the negative pressure supply unit 1 is supplied to the sample container holding unit 2, but the present invention is not limited to this. For example, as shown in FIG. 18, it may be configured such that negative pressure is supplied to the sample container holding unit 2 by using a negative pressure supply unit 19 that generates negative pressure by discharging air. Specifically, the negative pressure supply unit 19 includes a pump 17 that discharges air (provides positive pressure) and a T-shaped tube 18. When air is discharged by the pump 17 to the T-shaped tube 18 in the arrow A1-direction, negative pressure is generated in the T-shaped tube 18 in the arrow A2-direction. Therefore, as shown in FIG. 18, by arranging the sample container holding unit 2 at a position where negative pressure is generated in the negative pressure supply unit 19, negative pressure can be supplied to the sample container holding unit 2.

In the first embodiment, a configuration example is shown in which the vertical direction moving mechanism 5 (the first vertical direction moving mechanism 5a) moves the sample container holding unit 2 in the vertical direction by a rack and pinion mechanism, but the present invention is not limited thereto. As long as it is possible to move the sample container holding unit 2 in the vertical direction, the vertical direction moving mechanism 5 (first vertical direction moving mechanism 5a) may be configured in any way. The vertical direction moving mechanism 5 (the first vertical direction moving mechanism 5a) may be configured by, for example, a ball screw mechanism or a belt and pulley mechanism.

Further, in the above first embodiment, a configuration example is shown in which the vertical direction moving mechanism 5 (the second vertical direction moving mechanism 5b) moves the sample suction and discharge unit 3 in the vertical direction by the belt and pulley mechanism, but the present invention is not limited to this. As long as it is possible to move the sample suction and discharge unit 3 in the vertical direction, the vertical direction moving mechanism 5 (the second vertical direction moving mechanism 5b) may be configured in any way. The vertical direction moving mechanism 5 (the second vertical direction moving mechanism 5b) may be configured by, for example, a ball screw mechanism or a rack and pinion mechanism.

In the first and second embodiments, a configuration example is shown in which the sample container 10 is transferred from the first sample container placement portion 61 to the preprocessing unit 60 by the horizontal direction moving mechanism 4 and the vertical direction moving mechanism 5 to perform preprocessing by the preprocessing unit 60, but the present invention is not limited thereto. For example, it may be configured such that the sample transfer device 100 (200) is provided with a sample information reading unit for reading the information of the sample in the sample container 10 and the sample container 10 is moved from the first sample container placement portion 61 to a sample information reading unit by the horizontal direction moving mechanism 4 and the vertical direction moving mechanism 5.

Further, in the first and second embodiments, a configuration example is shown in which the sample transfer device 100 (200) transfers the sample container 10 from the first sample container placement portion 61 to the preprocessing unit 60 by the horizontal direction moving mechanism 4 and the vertical direction moving mechanism 5 and performs sample preprocessing, but the present invention is not limited to this. For example, in cases where it is not necessary to preprocess a sample, the sample transfer device 100 (200) is not required to provide the preprocessing unit 60. In the case of not providing the preprocessing unit 60, the sample transfer device 100 (200) may be configured to transfer the sample container 10 from the first sample container placement portion 61 to the second sample container placement portion 62 by the horizontal direction moving mechanism 4 and the vertical direction moving mechanism 5.

Further, in the first and second embodiments, a configuration example is shown in which the sample transfer device 100 (200) is provided with the notification unit 16, but the present invention is not limited to this. In cases where it is not necessary to notify the determination result 21 of the holding determination unit 8, the sample transfer device 100 (200) is not required to have the notification unit 16.

In the first and second embodiments, an example is shown in which the present invention is applied to the sample transfer device 100 (200) for moving the sample container holding unit 2 and the sample suction and discharge unit 3, but the present invention is not limited to this. The present invention may be applied to a transfer device not provided with the sample suction and discharge unit 3 and configured to perform only the transfer of the sample container 10.

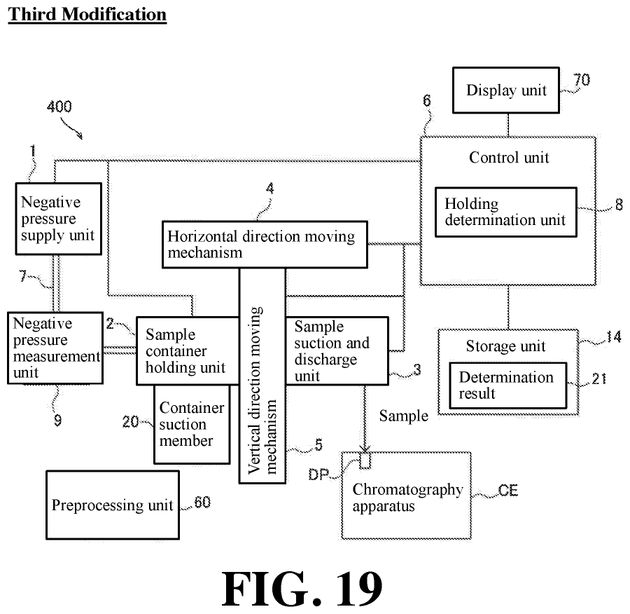

In the first and second embodiments, a configuration example is shown in which the notification unit 16 for notifying the negative pressure state of the container suction member 20 is provided, but the present invention is not limited to this. For example, like the sample transfer device 400 shown in FIG. 19, it may be configured to notify the user of the replacement time of the container suction member 20. The sample transfer device 400 is provided with a negative pressure supply unit 1, a sample container holding unit 2, a sample suction and discharge unit 3, a horizontal direction moving mechanism 4, a vertical direction moving mechanism 5, a control unit 6, and a negative pressure measurement unit 9, a storage unit 14, a notification unit 16, and a preprocessing unit 60, and a display unit 70. The configuration is the same as that of the sample transfer devices 100 and 200 in the first and second embodiments except that the display unit 70 is provided instead of the notification unit 16. The display unit 70 is configured to display the replacement time of the container suction member 20 under the control of the control unit 6. The display unit 70 includes, for example, a liquid crystal monitor.

The second negative pressure state can hold the sample container 10 by the container suction member 20, but indicates that the container suction member 20 is in a deteriorated state. That is, the second negative pressure state denotes a state in which it is better to replace the container suction member 20. Therefore, in the example shown in FIG. 19, the control unit 6 is configured to predict when the negative pressure state of the container suction member 20 changes from the first negative pressure state to the second negative pressure state and notify the user of the replacement time of the container suction member 20.

Specifically, the control unit 6 is configured to notify the user of the replacement time of the container suction member 20 by displaying the replacement time on the display unit 70. For example, assuming that the value of the first threshold value Th1 is 20 kPa and the predetermined pressure value AF is 30 kPa, if the magnitude of the negative pressure supplied to the container suction member 20 decreases by 0.5 kPa each month, the control unit 6 predicts that the predetermined pressure value AF will be 20 kPa after 20 months have elapsed. The control unit 6 notifies the user of the replacement time of the container suction member 20 by displaying the predicted replacement time (for example, after 20 months) on the display unit 70.

1. A sample transfer device comprising:
a negative pressure supply unit configured to supply negative pressure;
a sample container holding unit configured to hold a sample container;
a container suction member exchangeably attached to the sample container holding unit and configured to suction the sample container by the supplied negative pressure; and
a control unit configured to perform control to determine a state of the container suction member based on a predetermined pressure value determined based on a size of the container suction member and magnitude of the negative pressure in the container suction member.

2. The sample transfer device as recited in claim 1,
wherein the control unit is configured to perform control to distinguishably determined whether the container suction member has deteriorated or a shape of the container suction member is mismatched with respect to a lid portion of the sample container, based on the magnitude of the negative pressure.

3. The sample transfer device as recited in claim 2, further comprising:
a storage unit configured to store a determination result of the control unit,
wherein the control unit is configured to perform control to distinguishably determine whether the container suction member has deteriorated or the shape of the container suction member is mismatched with respect to the lid portion of the sample container, based on time series detection results of the negative pressure.

4. The sample transfer device as recited in claim 3,
wherein the control unit is configured to perform control to determine that the container suction member has deteriorated based on the magnitude of the negative pressure supplied to the container suction member, a first threshold value, and a second threshold value smaller than the first threshold value when the negative pressure has changed from a first negative pressure state in which the negative pressure is larger than the first threshold value to a third negative pressure state in which the negative pressure is equal to or smaller than the second threshold value via a second negative pressure state in which the negative pressure is equal to or smaller than the first threshold value and larger than the second threshold value.

5. The sample transfer device as recited in claim 3,
wherein the control unit is configured to perform control to determine that the shape of the container suction member is mismatched with respect to the lid portion of the sample container based on the magnitude of the negative pressure supplied to the container suction member, a first threshold value, and a second threshold value smaller than the first threshold value when the negative pressure has not become a first negative pressure state in which the negative pressure is greater than the first threshold value and has become a second negative pressure state in which the negative pressure is equal to or smaller than the first threshold value and larger than the second threshold value, or has become a third negative pressure state in which the negative pressure is equal to or smaller than the second threshold value.

6. The sample transfer device as recited in claim 4, further comprising:
a notification unit configured to notify that a state of the container suction member is which of the first negative pressure state, the second negative pressure state, and the third negative pressure state.

7. The sample transfer device as recited in claim 1, further comprising:
a holding determination unit configured to determine whether the sample container holding unit is holding the sample container based on the magnitude of the negative pressure supplied to the sample container holding unit.

8. The sample transfer device as recited in claim 1, further comprising:
a sample suction and discharge unit configured to suction a sample from the sample container and discharge the sample at a predetermined position;
a horizontal direction moving mechanism configured to integrally move the sample container holding unit together with the sample suction and discharge unit in a horizontal direction; and
a vertical direction moving mechanism configured to independently move the sample container holding unit and the sample suction and discharge unit in a vertical direction.

9. The sample transfer device as recited in claim 8, further comprising:
a preprocessing unit configured to perform preprocessing of the sample to be analyzed by a chromatography apparatus,
wherein the horizontal direction moving mechanism and the vertical direction moving mechanism are configured to move the sample container from a sample container placement portion to the preprocessing unit by moving the sample container holding unit to perform the preprocessing of the sample, and
wherein the sample suction and discharge unit is configured to suction the sample after the preprocessing and discharge the sample to a sample inlet port of the chromatography apparatus.
